(19) United States
(12) Patent Application Publication
(10) Pub. No.: US 2006/0103308 A1
(43) Pub. Date: May 18, 2006

(54) Plasma display panel

(75) Inventor: Tae-Joung Kweon, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/225,128

(22) Filed: Sep. 14, 2005

(30) Foreign Application Priority Data
Nov. 12, 2004 (KR) 10-2004-0092362

(51) Int. Cl. H01J 17/49

(52) U.S. Cl. 313/582; 313/583; 313/586

(57) ABSTRACT

A plasma display panel includes a front substrate, a back substrate opposing the front substrate, partition walls arranged between the front substrate and the back substrate to partition the discharge cells, front discharge electrodes surrounding discharge cells, and back discharge electrodes surrounding the discharge cells and spaced apart from the front discharge electrodes.

### CROSS-REFERENCE TO RELATED APPLICATION

This application claims priority to and the benefit of Korean Patent Application No. 10-2004-0092362, filed on Nov. 12, 2004, which is hereby incorporated by reference for all purposes as if fully set forth herein.

### BACKGROUND OF THE INVENTION

1. Field of the Invention

The present invention relates to a discharge electrode structure of a plasma display panel.

2. Discussion of the Background

Recently, display apparatuses including a plasma display panel (PDP) have been widely used. Such display apparatuses may be thin and lightweight, and they may provide high quality images on large screens having wide viewing angles. Additionally, the display apparatuses may be simply manufactured, and their size may be easily increased, compared to other flat panel display apparatuses. Therefore, display apparatuses using a PDP have been in the spotlight as next-generation large-sized flat display apparatuses.

In the conventional three-electrode surface-discharge PDP 100 of FIG. 1, about 40% of the visible rays coming from the fluorescent layers 110 are absorbed by the scanning electrodes 106, common electrodes 107, and bus electrodes 108 disposed on the lower surface of the front substrate 101, the dielectric layer 109 covering the electrodes 106, 107 and 108, and the protective layer 111, thereby decreasing luminous efficiency.

Further, when the PDP 100 displays the same image for a period of time, charged particles of discharge gas are implanted into the fluorescent layers 110, thereby burning an image into the PDP.

### SUMMARY OF THE INVENTION

The present invention provides a PDP having a novel structure.

Additional features of the invention will be set forth in the description which follows, and in part will be apparent from the description, or may be learned by practice of the invention.

The present invention discloses a PDP including a first substrate, a second substrate opposing the first substrate, partition walls arranged between the first substrate and the second substrate to partition discharge cells, first discharge electrodes surrounding the discharge cells, and second discharge electrodes surrounding the discharge cells and spaced apart from the first discharge electrodes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a conventional PDP.

FIG. 2 is an exploded perspective view showing a PDP according to an embodiment of the present invention.

FIG. 3 is a cross-sectional view along line III-III of FIG. 2.

FIG. 4 is a diagram showing discharge cells and electrodes of the PDP of FIG. 2.

### DETAILED DESCRIPTION OF THE ILLUSTRATED EMBODIMENT

The present invention will now be described more fully with reference to the accompanying drawings showing an exemplary embodiment of the present invention.

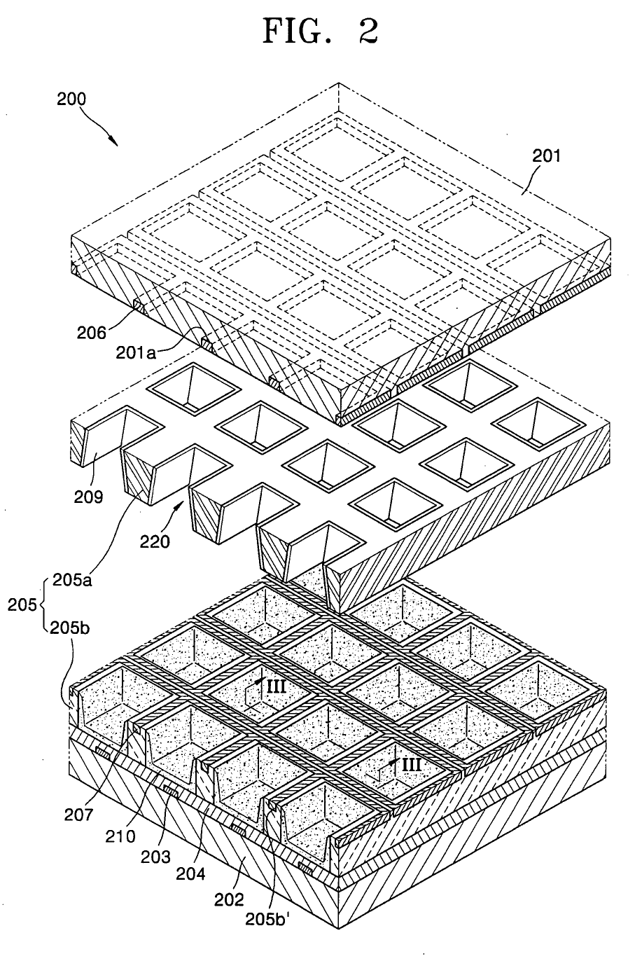

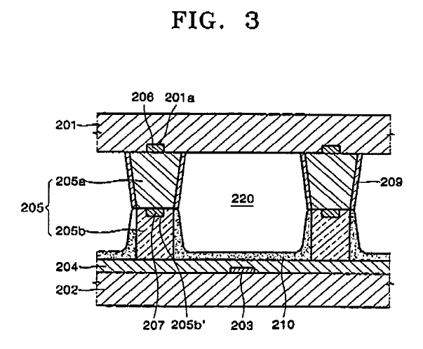

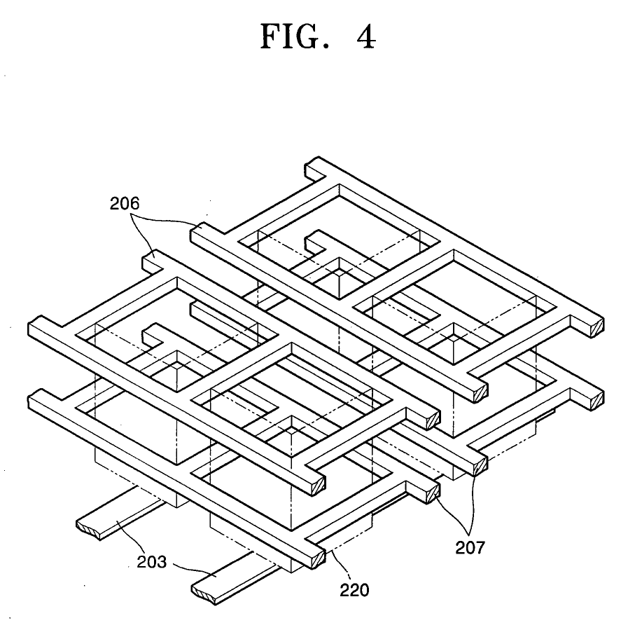

A PDP 200 according to an embodiment of the present invention will be described in detail with reference to FIG. 2, FIG. 3 and FIG. 4.

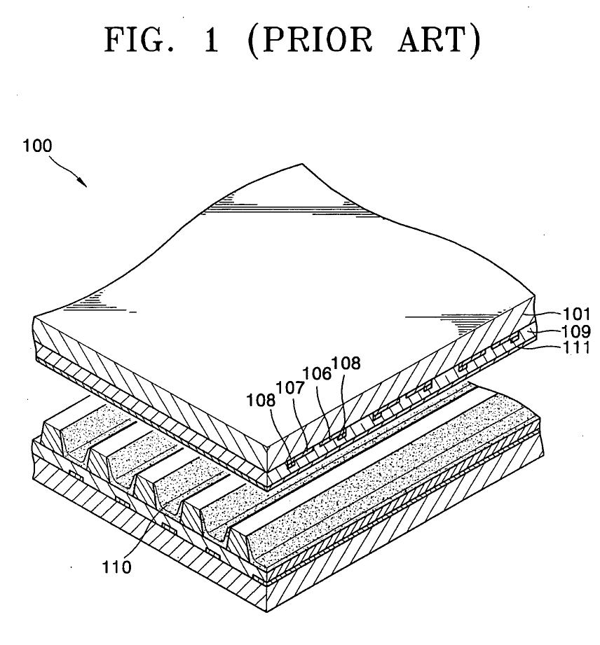

Referring to FIG. 2, FIG. 3 and FIG. 4, a front substrate 201 may be made of transparent material such as glass. Since light emitted from discharge cells of the PDP 200 travels through the front substrate 201, but not common electrodes, scan electrodes, and dielectric and protective layers as is the case with the PDP of FIG. 1, transmittance of visible rays is significantly improved. Therefore, when displaying an image at the brightness of a conventional technique, it is possible to drive the electrodes 203, 206, 207 of the PDP 200 with a relatively lower voltage, which improves luminous efficiency.

The back substrate 202 is arranged apart from and substantially parallel to the front substrate 201, and it may be made of material principally containing glass.

Partition walls 205 are arranged between the front substrate 201 and the back substrate 202 to partition the space between the front substrate 201 and the back substrate 202. In the present embodiment, the partition walls 205 include front partition walls 205a and rear partition walls 205b. The rear partition walls 205b are arranged behind the front partition walls 205a. The front partition walls 205a and the rear partition walls 205b may be formed as one body, or they may be separately formed. The details will be described below.

Specifically, in FIG. 2, the front partition walls 205a and the rear partition walls 205b partition discharge cells 220 in a matrix shape. However, the partition walls are not limited to the matrix shape because they may be formed in various patterns capable of forming a plurality of discharge cells. Further, a cross-section of the discharge cells 220 may have polygonal shapes such as a triangle, a pentagon, etc. or a circular or oval shape, etc., in addition to the quadrilateral shape shown in the present embodiment. The front partition walls 205a and the rear partition walls 205b may be formed in the same shape or in different shapes.

As FIG. 4 shows, front discharge electrodes 206 are arranged to surround the discharge cells 220. When the front discharge electrodes 206 are formed in the ladder shape, they extend to surround each of the discharge cells 220 arranged in one direction. The front discharge electrodes 206 are arranged in the front substrate 201. Specifically, first grooves 201a are formed on the back surface of the front substrate 201 to surround the discharge cells 220, and the front discharge electrodes 206 are arranged in the first grooves 201a. The first grooves 201a may be formed by sandblasting, etching, and other suitable methods for forming grooves.

Further, second grooves 205b′ are formed on the front surface of the rear partition walls 205b that faces the front partition walls 205a. The second grooves 205b′ and the first grooves 201a may be formed to be symmetrical to each other. The rear discharge electrodes 207 are arranged in the second grooves 205b′ and extend in one direction while surrounding the discharge cells 220. The front discharge electrodes 206 and the rear discharge electrodes 207 extend to be substantially parallel to each other in a front to back vertical direction. Here, the front discharge electrodes 206 and the rear discharge electrodes 207 may be formed to be symmetrical in a front to back direction.

The front discharge electrodes 206 and the rear discharge electrodes 207 are made of a metallic material such as aluminum, copper, etc.

Address electrodes 203 are arranged on the back substrate 202 to extend across the discharge cells 220, and they are substantially in parallel with each other. The address electrodes 203 extend in a direction crossing the front discharge electrodes 206 and the rear discharge electrodes 207. The address electrodes 203 generate an address discharge to select discharge cells to be sustain discharged and to allow the sustain discharge between the front electrodes 206 and the rear electrodes 207 to occur with a lower starting voltage. The address discharge occurs between scan electrodes and the address electrodes. When the address discharge ends, positive ions are stored at the scan electrodes' side and electrons are stored at common electrodes' side, whereby the sustain discharge between the scan electrodes and the common electrodes may occur more easily.

The shorter the distance between the scan electrodes and the address electrodes, the more efficient the address discharge. Therefore, in the present embodiment, the rear discharge electrodes 207 serve as the scan electrodes, and the front discharge electrodes 206 serve as the common electrodes.

It is preferable that the dielectric layer 204 covers the address electrodes 203. The dielectric layer 204 is arranged between the rear partition walls 205b and the back substrate 202, and it prevents positive ions or electrons from colliding with, and damaging, the address electrodes 203 during discharging, as well as induces wall charges. The dielectric layer 204 is made of a dielectric substance such as PbO, B₂O₃, SiO₂, etc.

Further, since the front partition walls 205a are interposed between the front discharge electrodes 206 and the rear discharge electrodes 207, which make plasma discharge occur, the front partition walls 205a are formed of a dielectric material that may induce charged particles to accumulate wall charges, prevent the front discharge electrodes 206 and the rear discharge electrodes 207 from being directly connected electrically during discharging, and prevent charged particles from colliding with, and damaging, the electrodes 206, 207. The dielectric material may be PbO, B₂O₃, SiO₂, etc. The rear partition walls 205b bury the rear discharge electrodes 207 in cooperation with the front partition walls 205a, and the rear partition walls 205b may be made of dielectric material.

Side surfaces of the front partition walls 205a may be covered by a protective layer 209. The protective layer 209 may be formed of a MgO layer. The protective layer 209 prevents charged particles from colliding with, and damaging, the front partition walls 205a, and it emits secondary electrons during discharging. In FIG. 2 and FIG. 3, the protective layer is formed on only side surfaces of the front partition walls 205a, but they are not limited thereto. For example, a protective layer may be formed on side surfaces of the rear partition walls 205b′ and so on.

As FIG. 2 and FIG. 3 show, side surfaces of the rear partition walls 205b and the front surface of the dielectric layer 204 between the rear partition walls 205b are coated with the fluorescent layer 210.

The fluorescent layer 210 receives ultraviolet rays and emits visible rays. The fluorescent layer formed in sub-pixels emitting red light may include a fluorescent substance such as Y(V, P)O₄:Eu, etc., the fluorescent layer formed in sub-pixels emitting green light may include a fluorescent substance such as Zn₂SiO₄:Mn, YBO₃:Tb, etc., and the fluorescent layer formed in sub-pixels emitting blue light may include a fluorescent substance such as BAM:Eu, etc.

Discharge gas such as Ne, Xe, etc., and a mixture thereof is filled and sealed in the discharge cells 220. According to exemplary embodiments of the present invention, since the discharge area may be increased and the discharge space may be enlarged, an amount of generated plasma increases, thereby enabling low-voltage driving. Therefore, even if highly-concentrated Xe gas is used as the discharge gas, low-voltage driving may be possible, thereby significantly increasing luminous efficiency. According to embodiments of the present invention, it is possible to overcome the difficultly in performing low-voltage driving when using highly-concentrated Xe gas as the PDP's discharge gas.

A method for manufacturing the PDP 100 will now be described in detail.

An upper plate and a lower plate of the PDP 200 may be separately produced and combined with each other by a sealing element such as frit glass. The upper plate includes the front substrate 201, the front discharge electrodes 206, the front partition walls 205a and the protective layer 209. The lower plate includes the back substrate 202, the address electrodes 203, the dielectric layer 204, the rear partition walls 205b, the fluorescent layer 210, and the rear discharge electrodes 207.

First, a method of manufacturing the upper plate is as follows.

After arranging a mask, which has a pattern of a shape corresponding to the front discharge electrodes 206, on the front substrate 201, the first grooves 201a may be formed by a sandblasting method. After forming the first grooves 201a, electrode materials are printed in the first grooves 201a, and then the front discharge electrodes 206 are formed through drying, exposure, developing, and baking processes. After forming the front discharge electrodes 206 in the first grooves 201a, a photosensitive dielectric substance is printed and dried on the front substrate 201, and then exposure is performed by using a photo mask having a pattern similar to that of a mask used in forming the first grooves 201a, and then the front partition walls 205a are formed through developing and baking processes. Thereafter, the protective layers 209 may be formed on side surfaces of the front partition walls 205a by using an evaporation method, etc.

Next, a method of producing the lower plate is as follows.

First, after forming the address electrodes 203 having a predetermined pattern on the back substrate 202, the dielectric layer 204 is formed to cover the address electrodes 203 by using a screen printing method. After forming the dielectric layer 204, the rear partition walls 205b are formed on the dielectric layer 204. The rear partition walls 205b may be formed by exposing a partition wall forming material using a photo mask having a pattern similar to that of the photo mask used in forming the front partition walls 205a and then developing and baking the material. After forming the rear partition walls 205b, the second grooves 205b′ may be formed on upper sides of the rear partition walls 205b using a photo etching method, etc. Shapes of the first grooves 201a and the second grooves 205b′ may be symmetrical. After forming the second grooves 205b′, electrode materials are printed in the second grooves, and then the rear discharge electrodes 207 are formed through drying, exposure, developing, and baking processes. After forming the rear discharge electrodes 207, the fluorescent layers 210 may be formed on the side surfaces of the rear partition walls 205b and on the dielectric layer 204 using a pattern printing method, a photosensitive paste method, etc.

On the other hand, if the front discharge electrodes and the rear discharge electrodes are formed within the front partition walls, electrode portions and partition wall portions made of a dielectric substance should be repeatedly formed, thereby increasing the number of processes. Further, a manufacturing process of the upper plate becomes complicated, as compared to the lower plate, thereby increasing processing time and manufacturing cost. However, because a PDP according to embodiments of the present invention may be made by using the above-mentioned manufacturing method, the number of manufacturing processes of the upper plate may be decreased, thereby decreasing a process time and improving a yield rate of the PDP.

In a PDP 200 according to an embodiment of the present invention having the above-mentioned structure, applying an address voltage between the address electrodes 203 and the rear discharge electrodes 207 generates an address discharge, which selects discharge cells 220 in which sustain discharge is to occur.

Thereafter, applying a sustain discharge voltage between the front discharge electrodes 206 and the rear discharge electrodes 207 of the selected discharge cells 220 generates a sustain discharge between the front discharge electrodes 206 and the rear discharge electrodes 207, thereby exciting the discharge gas. The discharge gas emits ultraviolet rays as its energy level decreases, thereby exiting the fluorescent layers 210 coated inside the discharge cells 220. Visible rays are emitted while energy level of the excited fluorescent layers 210 decreases, thereby displaying an image.

In the conventional PDP of FIG. 1, a discharge area is relatively narrow because the sustain discharge between the scan electrodes 106 and the common electrodes 107 occurs in a horizontal direction. However, the sustain discharge of the PDP 200 according to the present embodiment occurs in all side surfaces defining the discharge cells 220. Hence, a discharge area is relatively wide.

Further, the sustain discharge in the present embodiment occurs in the closed circle shape along side surfaces of the discharge cells 220 and gradually diffuses to central portions of the discharge cells 220. Accordingly, an area in which the sustain discharge occurs increases, and space charges inside the discharge cells, which may not be frequently used in the conventional PDP, contribute to light emitting. This enhances the PDP's luminous efficiency.

In the PDP according to the present embodiment, because the sustain discharge occurs in only portions defined by the front partition walls 205a, a problem with a conventional PDP, that is, ion sputtering of charged particles into fluorescent layers, is prevented, so that image burn in may not occur even if the same image is displayed for a period of time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate;
a second substrate opposing the first substrate;
partition walls arranged between the first substrate and the second substrate to partition discharge cells;
first discharge electrodes surrounding the discharge cells; and
second discharge electrodes surrounding the discharge cells and spaced apart from the first discharge electrodes.

2. The PDP of claim 1, wherein the first discharge electrodes are arranged in the first substrate and the second discharge electrodes are arranged in the partition walls.

3. The PDP of claim 2, wherein grooves surrounding each discharge cell are formed in a back surface of the first substrate, and the first discharge electrodes are arranged in the grooves.

4. The PDP of claim 3, wherein the grooves are formed in portions of the back surface of the first substrate corresponding to the partition walls.

5. The PDP of claim 2, wherein:
the partition walls include front partition walls and rear partition walls arranged behind the front partition walls,
grooves surrounding each discharge cell are formed in a front surface of the rear partition walls, and
the second discharge electrodes are arranged in the grooves.

6. The PDP of claim 5, further comprising a protective layer covering at least side surfaces of the front partition walls.

7. The PDP of claim 5, further comprising a fluorescent layer arranged on at least side surfaces of the rear partition walls.

8. The PDP of claim 1, wherein the second discharge electrodes extend in a direction crossing a direction in which the first discharge electrodes extend.

9. The PDP of claim 1, further comprising address electrodes extending in a direction crossing a direction in which the first discharge electrodes and the second discharge electrodes extend,
wherein the first discharge electrodes and the second discharge electrodes are arranged substantially parallel to each other.

10. The PDP of claim 9, further comprising a dielectric layer covering the address electrodes.

11. The PDP of claim 1, wherein the first discharge electrodes and the second discharge electrodes are arranged to be symmetrical in a front to back direction.

12. The PDP of claim 1, further comprising:
a fluorescent layer in the discharge cells; and
a discharge gas in the discharge cells.

13. The PDP of claim 1, wherein the partition walls include front partition walls and rear partition walls arranged behind the front partition walls, and
wherein the front partition walls are interposed between the first discharge electrodes and the second discharge electrodes.

14. The PDP of claim 13, wherein the front partition walls comprise a dielectric material.

15. The PDP of claim 13, wherein the first discharge electrodes are formed in first grooves in the first substrate, and
wherein the second discharge electrodes are formed in second grooves in the rear partition walls.

16. The PDP of claim 15, wherein the first grooves and the second grooves are symmetrical to each other.

17. A method for manufacturing a plasma display panel including a first substrate and a second substrate joined together with a plurality of discharge cells therebetween, comprising:
forming first grooves in the first substrate, the first grooves surrounding the discharge cells; and
forming first discharge electrodes in the first grooves.

18. The method of claim 17, further comprising:
forming rear partition walls on the second substrate;
forming second grooves in the rear partition walls, the second grooves surrounding the discharge cells; and
forming second discharge electrodes in the second grooves.

19. The method of claim 18, further comprising:
forming front partition walls on the first substrate; and
forming a protective layer on side surfaces of the front partition walls, wherein the front partition walls are interposed between the first discharge electrodes and the second discharge electrodes.

20. The method of claim 18, wherein the first grooves and the second grooves are symmetrical to each other.
